(19) United States
(12) Patent Application Publication
(10) Pub. No.: US 2020/0352300 A1
(43) Pub. Date: Nov. 12, 2020

(54) ELECTRONIC HANDBAG

(71) Applicant: Gina Abane Sube, Hialeah, FL (US)

(72) Inventor: Gina Abane Sube, Hialeah, FL (US)

(21) Appl. No.: 16/409,075

(22) Filed: May 10, 2019

(51) Int. Cl. A45C 15/00; A45C 3/06; A45C 13/00; A45C 13/02; G06F 1/16

(52) U.S. Cl. CPC A45C 15/00; A45C 3/06; A45C 2013/025; A45C 13/02; G06F 1/1628; A45C 13/001

(57) ABSTRACT

An electronic handbag is provided. The electronic handbag integrates a computing device so as to provide electronic functionality including tracking functionality and an external user interface for accessing the functionality and unlocking an enclosure. The enclosure provides a power source and charging plugs for powering smart devices adapted to be securely carried in the enclosure. The electronic handbag may also provide external solar panels for powering the power source and the other electronic functionality.

### BACKGROUND OF THE INVENTION

The present invention relates to handbags and, more particularly, to an electronic handbag.

The owners of handbags frequently carry their handbags all day, everywhere they go. And so, handbags regularly retain valuable and private items, as well as things that the owner depends on having access to. One such item is the owner's smart device. Smart devices, however, can only be powered on for as long as their battery allows, and so unfortunately such devices become disabled when being carried about in conventional handbags.

Moreover, conventional handbags are used mainly as fashion accessories, but we now live in a third generation where electronics should be applied to anything that is useful and that can serve us in many different ways including for problem solving, such as navigating a new city, and safety reasons.

As can be seen, there is a need for an electronic handbag that provides power to smart devices as well as keeps them secured against theft. The present invention also embodies a system of tracking the electronic handbag in case it is ever lost, misplaced or stolen, increasing the chances of finding and returning the valuables retained therein. Specifically, the handbag is also adapted to operatively associate with one or more smart devices to be able to track the location of the handbag in case of any theft or even in case of a kidnap.

The electronic handbag may also provide a user interface that displays electronic files for entertainment services, documents, storing or retrieving data, including a security code for moving the handbag between a locked and unlocked condition.

Furthermore, the electronic handbag may provide charging plugs for powering electronic gadgets through power generated via solar panels integrating into the electronic handbag.

### SUMMARY OF THE INVENTION

In one aspect of the present invention, an electronic handbag includes the following: a plurality of sidewalls defining an enclosure and an opening communicating thereto; a flap pivotably connected along a periphery of said opening for moving between an open position and a closed position; a lock clip provided along a periphery of the flap for engaging a portion of the plurality of sidewalls; a computing device integrated with the plurality of sidewalls; one or more user interfaces electrically coupled to the computing device, each user interface provided along an exterior surface of the plurality of sidewalls; the computing device configured for positioning the lock clip between a locked engagement and an unlocked engagement with said portion of the plurality of sidewalls through inputting a code by way at least one of the user interfaces; and one or more solar panels provided along an upward-facing surface of the flap, wherein each solar panel is electrically connected to the computing device.

In another aspect of the present invention, the electronic handbag includes the following a plurality of sidewalls defining an enclosure and an opening communicating thereto; a flap pivotably connected by way of an electromechanical hinge to a periphery of said opening for moving between an open position and a closed position; a lock clip provided along a periphery of the flap for engaging a portion of the plurality of sidewalls; a computing device integrated with the plurality of sidewalls; one or more user interfaces electrically coupled to the computing device, each user interface provided along an exterior surface of the plurality of sidewalls; the computing device configured for positioning the lock clip between a locked engagement and an unlocked engagement with said portion of the plurality of sidewalls through inputting a code by way at least one of the user interfaces, wherein the computing device is configured to provide tracking functionality so that an operatively associated smart device can track the physical location of the handbag; one or more solar panels provided along an upward-facing surface of the flap, wherein each solar panel is electrically connected to the computing device; a powering device in the enclosure, wherein the power device is electrically coupled to each solar panel, and wherein the power device is configured to provide power to one or more independent smart devices; and a band for removably securing each smart device along an inner surface of the plurality of sidewalls while each smart device is being charged by the powering device.

These and other features, aspects and advantages of the present invention will become better understood with reference to the following drawings, description and claims.

### BRIEF DESCRIPTION OF THE DRAWINGS

FIG. 1 is a perspective view of a first side of an exemplary embodiment of the present invention;

FIG. 2 is an exploded view of an opposing second side of an exemplary embodiment of the present invention;

FIG. 3 is a perspective view of an exemplary embodiment of the present invention, illustrating a top flap to an open position;

FIG. 4 is a top plan view of an exemplary embodiment of the present invention, illustrated without the top flap for clarity;

FIG. 5 is a detail view of an exemplary embodiment of a touchscreen stylus of the present invention;

FIG. 6 is a detail perspective view of an exemplary embodiment of a wireless earpiece of the present invention;

FIG. 7 is a schematic view of an exemplary embodiment of accessing the present invention; and

FIG. 8 is a schematic view of an exemplary embodiment of a control circuitry of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electronic handbag. The electronic handbag integrates a computing device so as to provide electronic functionality including tracking functionality and an external user interface for accessing the functionality and unlocking an enclosure. The enclosure provides a power source and charging plugs for powering smart devices adapted to be securely carried in the enclosure. The electronic handbag may also provide external solar panels for powering the power source and the other electronic functionality.

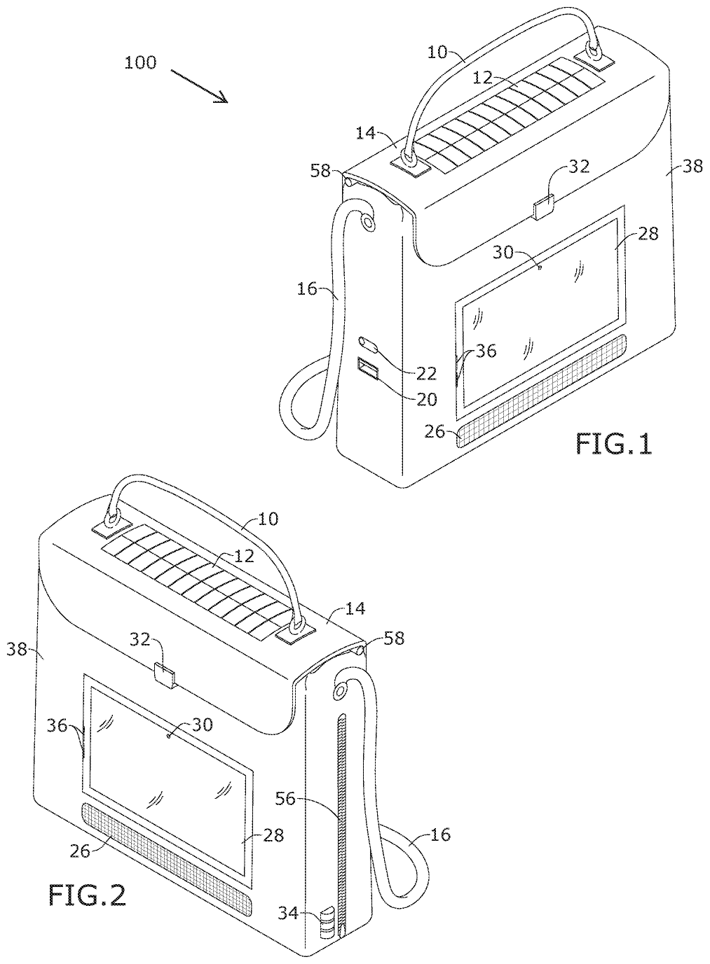

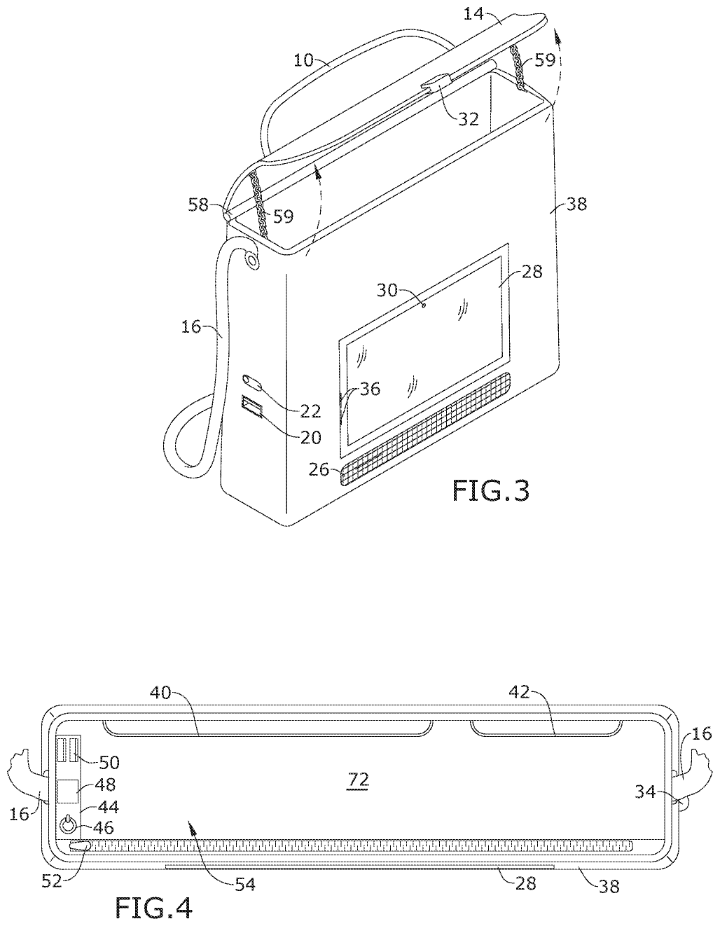

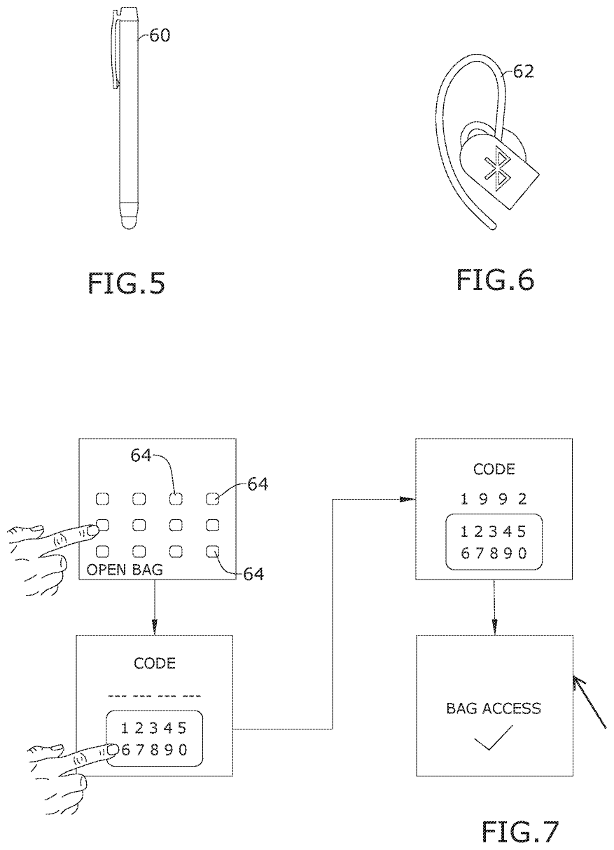

Referring to FIGS. 1 through 8, the present invention may include an electronic handbag 100 providing a plurality of sidewalls 38 defining an enclosure 54 and an opening 72 communicating with said enclosure 54. A flap 14 may be pivotably connected along a periphery of the opening so as to move between a closed position (FIGS. 1 and 2) for closing off the enclosure 54 and an open position (FIG. 3) for accessing the enclosure 54. A stepper motor 58 or powered hinge may be provided to electrically facilitate such movement. Restraints 59 may also be provided to prevent the flap 14 from moving to the open position too far or too quickly.

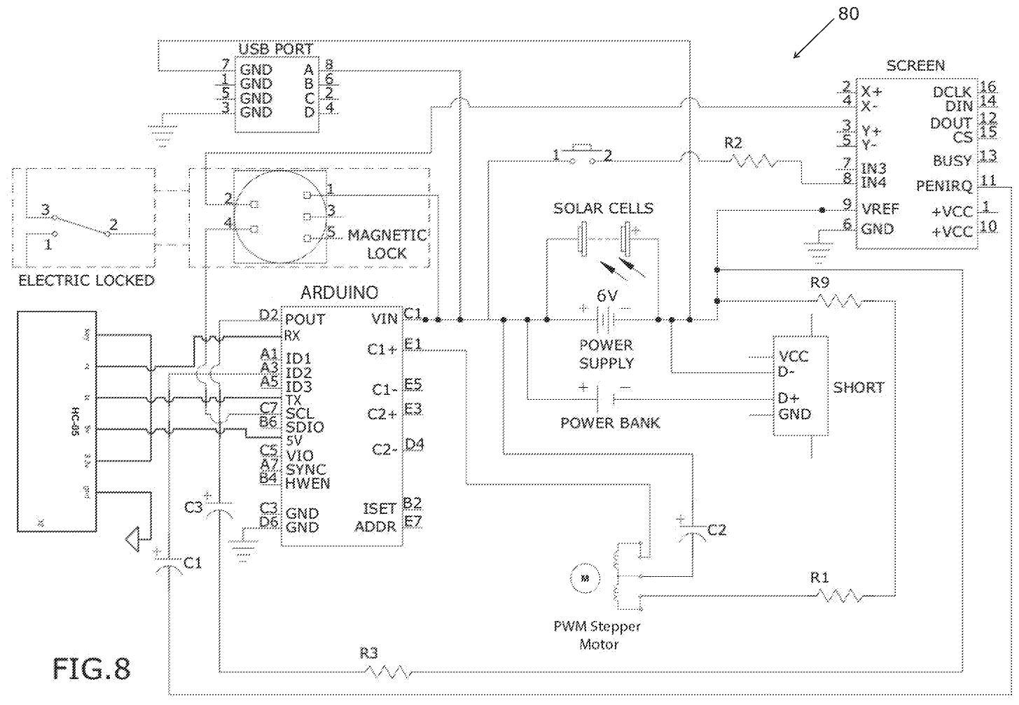

The electronic handbag 100 may include at least one computing device with one or more user interfaces 28. The computing device may include at least one processing unit coupled to a form of memory. The computing device may include, but not limited to, a microprocessor, a server, a desktop, laptop, and smart device, such as, a tablet and smart phone. The computing device includes a program product including a machine-readable program code for causing, when executed, the computing device to perform steps. The program product may include software which may either be loaded onto the computing device or accessed by the computing device. The loaded software may include an application on a smart device. The software may be accessed by the computing device using a web browser. The computing device may access the software via the web browser using the internet, extranet, intranet, host server, internet cloud and the like. The computing device may be operatively associated with a control circuitry 80 (see FIG. 8) for driving the functionality disclosed herein, such as the user interface 29. The control circuitry 80 may provide tracking device, security software, and entertainment services functionality.

The user interfaces 28 may be disposed along the outer surface of the sidewalls 38 so that users can utilize one of the user interfaces 28 to gain access tot the enclosure 54. The flap 14 may provide a locking clip 32 so that in the closed position, the flap 14 may be selectively positioned between a locked condition. and an unlocked condition via the user interface 28, as illustrated in FIG. 7, through entering a code of lock inputs 64. The user interface 28 may also provide an image capturing functionality 30, such as a camera.

The flap 14 may also provide a handle 10 for manually toting the handbag 100. Solar panels 12 may also be provided along an upward-facing surface of the flap 14.

The sidewalls 38 may provide an on/off button for the computing device. The sidewalls 38 may provide exterior USB ports 20, SD and SIM card ports 36, and one or more speakers 26. The sidewalls 38 may provide a shoulder strap 16. The sidewalls 38 may provide an alternative access via an outer detachable fastener 56.

Within the enclosure 54 or at least in a space enclosed in the closed position, the present invention may include the power bank 44 (powered via the solar panels 12), a power button 46, a power indicator 48, and USB ports 50. Along an inner surface of the enclosure 54 the electronic handbag 10 may provide bands 40 and 42 for removably retaining large and small smart devices. Within the enclosure 54 there may also be an inner pouch accessible through an inner detachable fastener 52. The enclosure 54 may also provide support for securing an input device 60, such as a stylus, and wireless communication devices 62 such as earpieces.

A method of using the present invention may include the following. The electronic handbag 100 disclosed above may be provided. A user may enter their personal code to access the user interface 28 and then access different services that are represented on the user interface 28 or gain access to the enclosure 54 by moving the lock clip 32 to the unlocked condition. The tracking device functionality may be connected to a smart device so as to enable the electronic handbag 100 to be tracked when needed. The solar panels 12 generate power for above-mentioned functionality.

The computing device-based data processing system and method described above is for purposes of example only, and may be implemented in any type of computing device system or programming or processing environment, or in a computing device program, alone or in conjunction with hardware. The present invention may also be implemented in software stored on a computing device-readable medium and executed as a computing device program on a general purpose or special purpose computing device. For clarity, only those aspects of the system germane to the invention are described, and product details well known in the art are omitted. For the same reason, the computing device hardware is not described in further detail. It should thus be understood that the invention is not limited to any specific computing device language, program, or computing device. It is further contemplated that the present invention may be run on a stand-alone computing device system, or may be run from a server computing device system that can be accessed by a plurality of client computing device systems interconnected over an intranet network, or that is accessible to clients over the Internet. In addition, many embodiments of the present invention have application to a wide range of industries. To the extent the present application discloses a system, the method implemented by that system, as well as software stored on a computing device-readable medium and executed as a computing device program to perform the method on a general purpose or special purpose computing device, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. An electronic handbag, comprising:
a plurality of sidewalls defining an enclosure and an opening communicating thereto;
a flap pivotably connected along a periphery of said opening for moving between an open position and a closed position;
a lock clip provided along a periphery of the flap for engaging a portion of the plurality of sidewalls;
a computing device integrated with the plurality of sidewalls;
one or more user interfaces electrically coupled to the computing device, each user interface provided along an exterior surface of the plurality of sidewalls;
the computing device configured for positioning the lock clip between a locked engagement and an unlocked engagement with said portion of the plurality of sidewalls through inputting a code by way at least one of the user interfaces; and
one or more solar panels provided along an upward-facing surface of the flap, wherein each solar panel is electrically connected to the computing device.

2. The electronic handbag of claim 1, further comprising a powering device in the enclosure, wherein the power device is electrically coupled to each solar panel, and wherein the power device is configured to provide power to one or more independent smart devices.

3. The electronic handbag of claim 2, further comprising a band for removably securing each smart device along an inner surface of the plurality of sidewalls while each smart device is being charged by the powering device.

4. The electronic handbag of claim 1, further comprising an electromechanical hinge interconnecting the flap and the periphery of the opening.

5. The electronic handbag of claim 1, wherein the computing device is configured to provide tracking functionality so that an operatively associated smart device can track the physical location of the handbag.

6. An electronic handbag, comprising:
a plurality of sidewalls defining an enclosure and an opening communicating thereto;
a flap pivotably connected by way of an electromechanical hinge to a periphery of said opening for moving between an open position and a closed position;
a lock clip provided along a periphery of the flap for engaging a portion of the plurality of sidewalls;
a computing device integrated with the plurality of sidewalls;
one or more user interfaces electrically coupled to the computing device, each user interface provided along an exterior surface of the plurality of sidewalls;
the computing device configured for positioning the lock clip between a locked engagement and an unlocked engagement with said portion of the plurality of sidewalls through inputting a code by way at least one of the user interfaces, wherein the computing device is configured to provide tracking functionality so that an operatively associated smart device can track the physical location of the handbag;
one or more solar panels provided along an upward-facing surface of the flap, wherein each solar panel is electrically connected to the computing device;
a powering device in the enclosure, wherein the power device is electrically coupled to each solar panel, and wherein the power device is configured to provide power to one or more independent smart devices; and
a band for removably securing each smart device along an inner surface of the plurality of sidewalls while each smart device is being charged by the powering device.
